(19) United States
(12) Patent Application Publication
(10) Pub. No.: US 2018/0268540 A1
(43) Pub. Date: Sep. 20, 2018

(54) APPARATUS AND METHOD OF INDICATING DISPLACEMENT OF OBJECTS

(71) Applicant: ClearEdge3D, Inc., Marshall, VA (US)

(72) Inventors: John SLOAN, Manassas, VA (US); Kevin S. WILLIAMS, Marshall, VA (US)

(21) Appl. No.: 15/923,654

(22) Filed: Mar. 16, 2018

Related U.S. Application Data
(60) Provisional application No. 62/472,959, filed on Mar. 17, 2017.

(51) Int. Cl. G06T 7/00; G06F 17/50

(52) U.S. Cl. CPC G06T 7/0006; G06F 17/50

(57) ABSTRACT

A method for indicating and computing displacement of Elements with respect to corresponding Design Locations of the Elements. The method comprising loading, through a data interface, data describing a set of measurements (Measurement Data) of one or more Elements in a Scene. The method further comprising receiving data describing the geometry of one or more Elements (Design Models) that are expected to exist in the Scene. The method further comprising receiving data describing the Design Location(s) of these Elements. The method further comprising enabling a user to place a graphical representation of the Design Model in an Approximate Installed Location indicated by the Measurement Data. The method further comprising measuring and reporting the spatial differences between the Design Location and an Approximate Installed Location as indicated by the user-positioned graphical representation of the Design Model.

### BACKGROUND

Large construction projects are usually designed on a computer as a virtual model. This virtual model becomes the plan in accordance with which the physical structure is built. Construction crews then attempt to build the structure to resemble the plan (the virtual model) as closely as possible.

In attempting to follow the plan (the virtual model), construction crews inevitably make mistakes. For instance, the virtual model may call for a column to be placed in the center of a building, but the column might actually be installed three inches to the left because of a measurement error. Sometimes these mistakes are insignificant; other times they may be very costly. If these mistakes could be caught early in the process, much of the expense could be mitigated.

One common method for catching these mistakes is to compare the virtual design model (Design Model in its Design Location) to a 3D scan of the actual construction site, e.g., a point cloud representation of the site (Measurement Data showing the Installed Location). The design model can be overlaid on top of the point cloud, and measurements taken between the model and the points in the point cloud to determine the offset distance or displacement between the Designed Location and the Installed Location. These measurements require significant manual work, as multiple measurements across the body of the element are generally required in order to get an average or representative displacement. This technique is also subject to bias, as it is left to the discretion of the person measuring to choose the points to use for the measurement.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a high level block diagram of a computer configured in accordance with an embodiment of the present invention.

FIG. 2 is a flowchart of the operation for enabling a user to graphically indicate an Approximate Installed Location of an Element based on Measurement Data in accordance with an embodiment of the present invention.

FIG. 3 is an image of a Design Model of an Element in its Design Location, and a set of measurement points representing the Installed Location of that Element in accordance with an embodiment of the present invention. The arrow illustrates the process of moving the model from the Design Location to an Approximate Installed Location as indicated by the measurement points.

FIG. 4 is an image of four views of a stair-shaped Element according to an embodiment of the present invention.

FIG. 5 is an image showing the reported distance and direction of the offset between the Design Location and an Approximate Installed Location.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

One or more embodiments provide a method of and an apparatus for indicating displacement of objects. One or more of the present embodiments provide a system, a method, and an apparatus to easily compare construction in the real world against the virtual design model and measure the positional differences between the two to identify the positional differences and enable further actions to be taken based on the positional differences. In accordance with one or more embodiments, further actions to be taken could include revision of the virtual design model to reflect the positional differences, revision of the real world construction to align more closely with the virtual design model, revision of the virtual design to produce one or more intermediate remediation possibilities to correct the real world construction, or other similar actions.

Various features associated with the operation of embodiments of the present invention will now be set forth. Prior to such description, a glossary of terms applicable for at least some embodiments is provided.

Scene: According to some embodiments, a scene includes or refers to a set of one or more physical objects.

Measurement Data: According to some embodiments, measurement data refers to any data describing the spatial arrangement of objects in space, and may include photography, laser scan data, survey data, or any other spatial measurements.

Point Cloud: According to some embodiments, a point cloud is a collection of measurement points of a scene. These measurement points may be acquired using a laser scanner, photogrammetry, or other similar 3D measurement techniques.

Element: According to some embodiments, an Element is a physical object that is installed during construction, such as an I-beam, a pipe, a wall, or a duct.

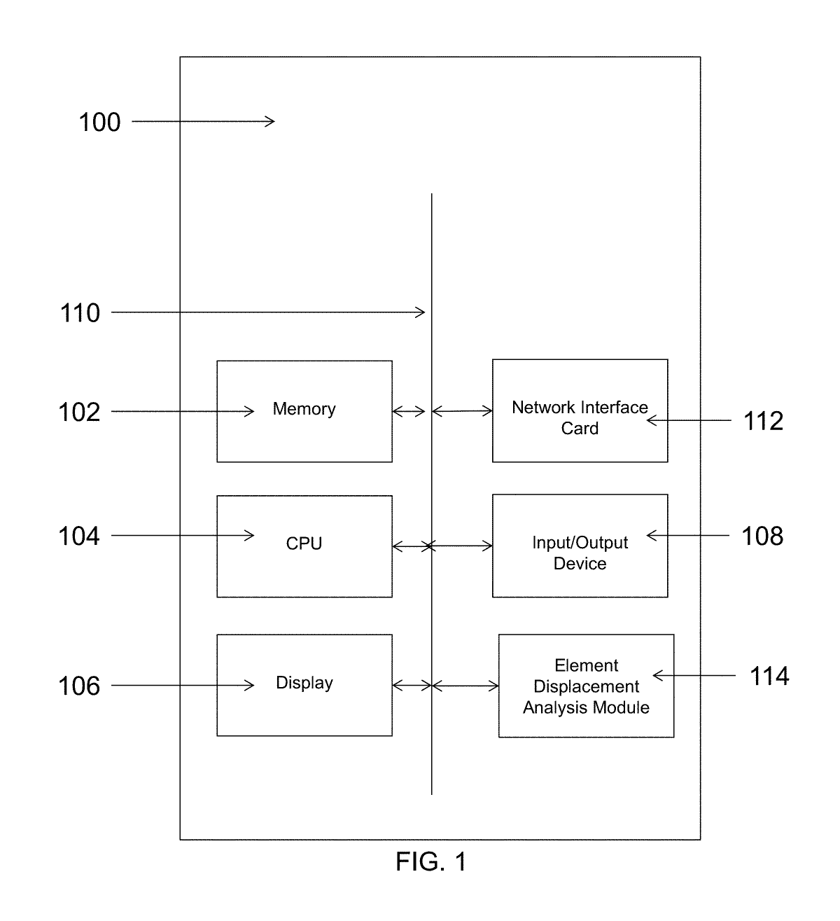

Virtual Model: According to some embodiments, a Virtual Model includes a set of data, residing in a memory, e.g., a memory 102 (FIG. 1) of a computer system 100, that describes a Design Model.

Design Model: According to some embodiments, a Design Model is a Virtual Model that describes the geometry of one or more Elements. In some embodiments, a Design Model is a collection of one or more faces that describe the boundary or a portion of the boundary of a set of one or more objects. For example, a Design Model that contains the top and bottom faces of a cube would be a Design Model that describes a portion of the boundary of the cube. Similarly, a Design Model containing all six faces of a cube would be a 3D model that describes the (entire) boundary of the cube. In at least one embodiment, the Design Model accurately reflects the shape and physical dimensions of the actual physical Element being represented.

Perspective Vector: According to some embodiments, the Perspective Vector for a graphical display is the normal vector to the plane of the display screen. For example, when a building is displayed from the perspective of a bird looking down at the roof, the Perspective Vector is the downward-pointing vector.

Design Location: According to some embodiments, the Design Location is the spatial location where the Design Element is intended to be installed.

Installed Location: According to some embodiments, the Installed Location is the actual location where the Element is installed. The Installed Location will be approximately the same as the Design Location when an Element is properly installed. However, if the Element is not properly installed (i.e., if it is installed in the wrong place), the Installed Location may differ significantly from the Design Location.

Approximate Installed Location: An apparent Installed Location based on matching a graphical representation of the Design Model to the Measurement Data of an installed Element.

Data Interface: According to some embodiments, a data interface includes a portion of a computer system that allows data to be loaded onto the computer system. In some embodiments a Network Interface Card 112 (FIG. 1) operates as a data interface, allowing data to be loaded across a network. In some embodiments, an input/output device operates as a data interface. In some embodiments, a removable memory device or removable memory media operates as a data interface, allowing data to be loaded by attaching the device or by loading the media. This list of embodiments is not exclusive; other forms of a data interface appear in other embodiments.

The following paragraphs describe one or more embodiments for indicating and computing displacement of Elements away from their Design Locations. Some method embodiments receive, through a data interface, data describing a set of measurements (Measurement Data) of one or more Elements in a Scene. Some method embodiments receive data describing the geometry of one or more Elements (Design Models) that are expected to exist in the Scene. Some method embodiments comprise receiving data describing the Design Location(s) of these Elements. Some method embodiments comprise enabling a user to place a graphical representation of the Design Model in an Approximate Installed Location indicated by the Measurement Data. Some method embodiments comprise measuring and reporting the spatial differences between the Design Location and an Approximate Installed Location as indicated by the user-positioned graphical representation of the Design Model. Some embodiments of the method are implemented in software, e.g., a set of instructions stored in a non-transitory medium for execution by a computer system, hardware, firmware, or a combination thereof.

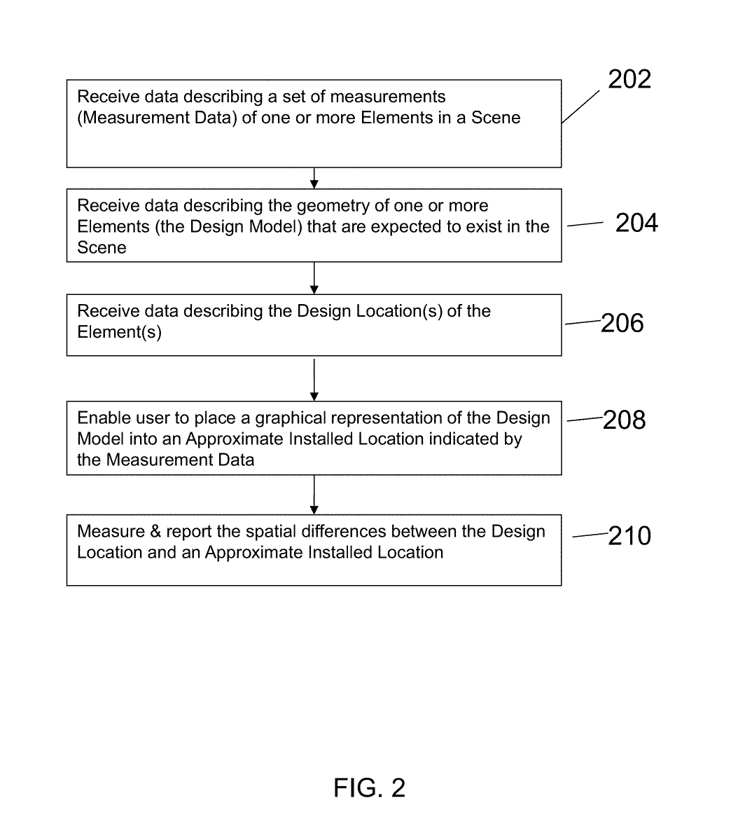

FIG. 1 is a high level block diagram of a computer system 100 configured in accordance with some embodiments of the present invention, wherein the computer system 100 is programmed, e.g., configured to execute a set of one or more instructions stored, for example, in memory 102, with a method according to some embodiments, e.g., the method described in connection with FIG. 2. In some embodiments, the computer system 100 includes components suitable for use in 3D modeling. In some embodiments, the computer system 100 includes one or more of various components, such as memory 102, a central processing unit (CPU) or controller 104, a display 106, input/output devices 108, and/or a bus 110. In some embodiments, the CPU comprises one or more individual processing units. In some embodiments, the bus 110 or another similar communication mechanism transfers information between the components of the computer system, such as memory 102, CPU 104, display 106 and/or input/output devices 108. In some embodiments, information is transferred between some of the components of the computer system or within components of the computer system via a communications network, such as a wired or wireless communication path established with the internet, for example. In some embodiments, the memory 102 includes a non-transitory, computer readable, storage medium. In some embodiments, the memory 102 includes a volatile and/or a non-volatile computer readable storage medium. In some embodiments, memory 102 stores a set of instructions to be executed by the CPU 104. In some embodiments, memory 102 is also used for storing temporary variables or other intermediate information during execution of instructions to be executed by the CPU 104. In some embodiments, the instructions to be executed by the CPU 104 are stored in a portion of the memory 102 that is a non-transitory, computer readable, storage medium. In some embodiments, the instructions for causing a CPU 104 and computer system 100 to perform the described steps and tasks can be located in memory 102. In some embodiments, these instructions can alternatively be loaded from a disk and/or retrieved from a remote networked location. In some embodiments, the instructions reside on a server, and are accessible and/or downloadable from the server via a data connection with the data interface. In some embodiments, the data connection may include a wired or wireless communication path established with the Internet, for example.

In some embodiments, a Network Interface Card (NIC) 112 is included in the computer system 100, and provides connectivity to a network (not shown), thereby allowing the computer system 100 to operate in a networked environment. In some embodiments, computer system 100 is configured to receive data such as measurements that describe portions of a scene through the NIC 112 and/or the input/output devices 108.

In some embodiments, the memory 102 includes one or more executable modules to implement operations described herein. In some embodiments, the memory 102 includes an Element displacement analysis module 114. In some embodiments, the Element displacement analysis module 114 includes software for analyzing a set of point cloud data, an example of such software includes Verity™ which is developed by ClearEdge 3D, Manassas, Va. In some embodiments, the Element displacement analysis module 114 also includes executable instructions for indicating the displacement of one or more Elements within a scene. The operations performed by such an Element displacement analysis module 114 are discussed in greater detail in connection with FIG. 2 below.

It should be noted that the Element displacement analysis module 114 is provided by way of example. In some embodiments, additional modules, such as an operating system or graphical user interface module are also included. It should be appreciated that the functions of the modules may be combined. In addition, the functions of the modules need not be performed on a single machine. Instead, the functions may be distributed across a network, if desired. Indeed, some embodiments of the invention are implemented in a client-server environment with various components being implemented at the client-side and/or server-side.

In some embodiments, the CPU 104 processes information and instructions, e.g., stored in memory 102.

In some embodiments, the computer system 100 further comprises a display 106, such as a liquid crystal display (LCD), cathode ray tube (CRT), or other display technology, for displaying information to a user. In some embodiments, a display 106 is not included as a part of computer system 100. In some embodiments, the computer system 100 is configured to be removably connected with a display 106.

In some embodiments, the memory 102 comprises a static and/or a dynamic memory storage device such as a hard drive, optical and/or magnetic drive, and similar storage devices for storing information and/or instructions. In some embodiments, a static and/or dynamic memory storage device and/or media 102 is configured to be removably connected with the computer system 100. In some embodiments, data such as measurements that describe portions of a scene are received by loading a removable media onto memory storage device 102, for example by placing an optical disk into an optical drive, a magnetic tape into a magnetic drive, or similar data transfer operations. In some embodiments, data such as measurements that describe portions of a scene are received by attaching a removable static and/or dynamic memory storage device 102, such as a hard drive, optical, and/or magnetic drive, or similar devices to the computer system 100. In some embodiments, data such as measurements that describe portions of a scene are received through NIC 112 or Input/Output Devices 108.

FIG. 2 is a flowchart of processing operations for indicating and computing displacement of Elements in accordance with one or more embodiments of the invention. An exemplary set of operations (202-210) for analyzing the displacement of Elements is discussed in detail below. In some embodiments, some or all of the exemplary set of operations (202-210) are stored in memory 102 as a sequence of instructions for execution by CPU 104.

### Operation of Receiving, Through a Data Interface, Data Describing a Set of Measurements (Measurement Data) of One or More Elements in a Scene

An operation to receive, through a data interface, data describing a set of measurements of one or more elements in the scene is performed (block 202), e.g., by computer system 100. In some embodiments, a computer system receives, through a data interface, a data set describing a set of measurements of one or more elements in a scene. For example, in some embodiments a data file containing a set of one or more laser scans may be loaded onto a computer system 100 through a network interface card 112 and stored in memory 102 as illustrated in FIG. 1. As another example, in some embodiments an optical storage disk containing photogrammetric measurements of a factory are placed in an optical disk drive.

In some embodiments, a cloud of point measurements of a scene (which in some embodiments is called a “point cloud”) is loaded into the memory 102 of a computing device 100 for processing as illustrated in FIG. 1.

It should be noted that this is not an exhaustive list of embodiments of the invention, other embodiments are possible.

Operation of Receiving Data Describing the Geometry of One or More Elements (the Design Model) that are Expected to Exist in a Scene

An operation to receive data describing the geometry of one or more Elements that are expected to exist in the Scene is performed (block 204). In some embodiments, a computer system receives a data set describing that geometry. For example, in some embodiments, a data file containing a set of one or more CAD (Computer Assisted Design) models or BIM (Building Information Model) models may be loaded onto a computer system 100 through a network interface card 112 (FIG. 1) and stored in memory 102. In at least one embodiment, the geometry of the Design Model accurately reflects the geometry (the shape and physical dimensions) of the actual physical Element expected to be present in the Scene.

It should be noted that this is not an exhaustive list of embodiments of the invention, other embodiments are possible.

### Operation of Receiving Data Describing the Design Location(s) of the Element(s)

An operation to receive data describing the Design Location(s) of the Element(s) is performed (block 206), e.g., by computer system 100. In some embodiments, a computer system receives this data in the form of a positional offset and rotation relative to a fixed coordinate system in the Scene. In some embodiments, the Design Location of the Element is embedded in the geometry of the Design Model. In some embodiments, the Design Location is separate from the geometry of the Design Model.

It should be noted that this is not an exhaustive list of embodiments of the invention, other embodiments are possible.

### Operation of Enabling User to Place a Graphical Representation of the Design Model in an Approximate Installed Location Indicated by the Measurement Data

An operation is performed to enable a user to place a graphical representation of the Design Model in an Approximate Installed Location as indicated by the Measurement Data (block 208), e.g., by computer system 100. In some embodiments, the Measurement Data is a Point Cloud and is displayed graphically in a 3D viewer. In some embodiments, the Measurement Data is displayed graphically in a 2D viewer. In some embodiments, the Design Model is displayed in the same viewer containing the Measurement Data and is displayed at the same scale as the Measurement Data, such that if the two were laid on top of each other, they would occupy the same graphical space.

In some embodiments, the user can spatially translate and rotate the Design Model to visually align with the Measurement Data such that the Design Model occupies the same graphical space as the Measurement Data. In some embodiments, after the Design Model is aligned to occupy essentially the same graphical space as the Measurement Data (i.e., the Design Model visually falls on top of the Measurement Data of the physical Element), the Design Model is said to be positioned in an Element's Approximate Installed Location as indicated by the Measurement Data.

In some embodiments, the Design Model is initially positioned at the Design Location, and the user can spatially translate and rotate the Design Model from this starting position. In some embodiments, the Design Model is initially positioned at a location that has been automatically fitted to the Measurement Data, and the user can move the Design Model from this position. In some embodiments, the Design Model is initially positioned at an arbitrary location.

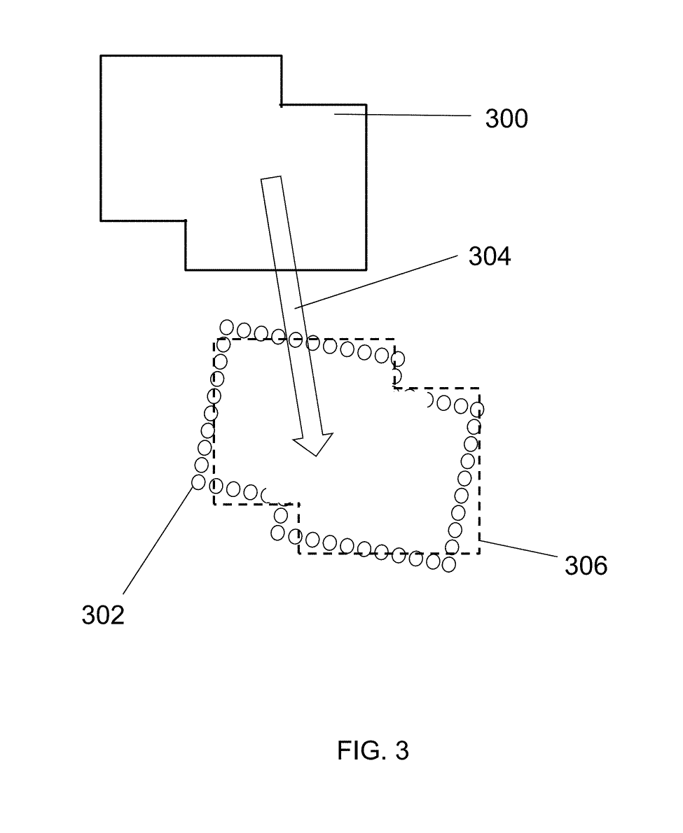

FIG. 3 is an image of a Design Model in the Design Location (300), along with Measurement Data in the form of a Point Cloud (302) showing the Installed Location of the Element according to blocks 202, 204, and 206. In some embodiments, the user is able to drag the Design Model or a copy of the Design Model down and to the right (indicated by arrow 304) such that the Design Model overlays the Point Cloud (302), and this new position of the Design Model is said to be the Element's Approximate Installed Location (306).

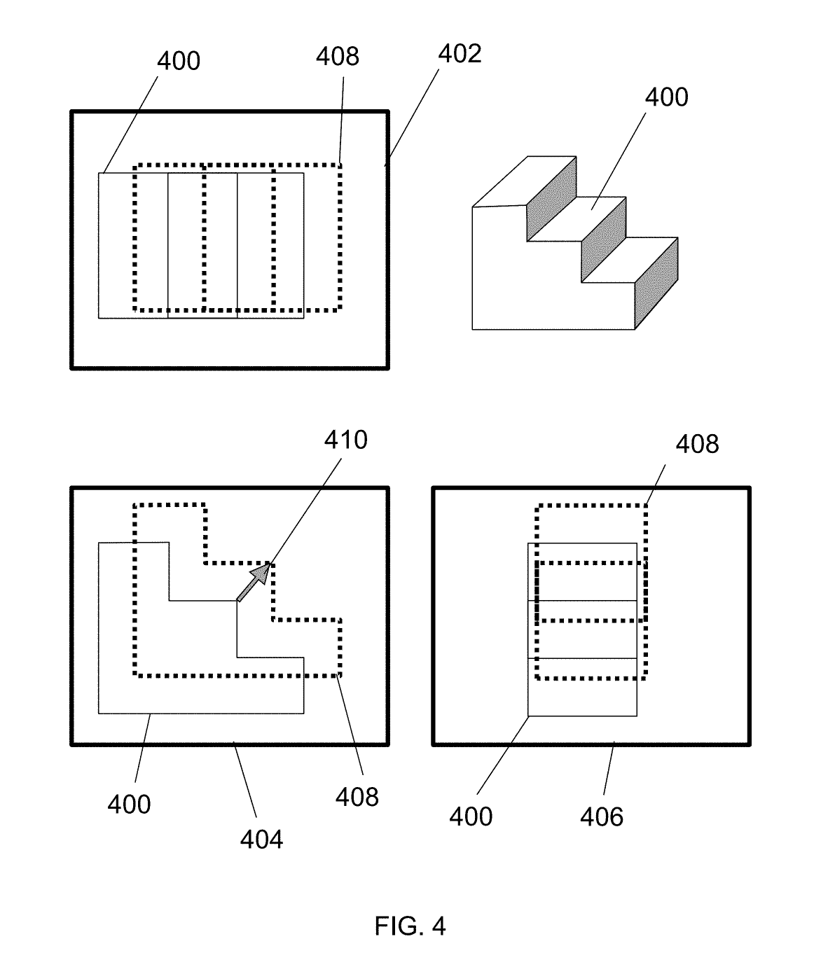

In some embodiments, the Design Model and Measurement Data are displayed in one or more independent orthographic views as shown in FIG. 4, and each view (402, 404, 406) allows the user to drag the Design Model or a copy of the Design Model in the two dimensions that are orthogonal to the Perspective Vector of that view. FIG. 4 includes three different standard orthographic views of a 3D Design Model (400) of the stair-shaped Element. Each of the three views represents a separate, independent and interactive graphical display of the same Design Model from three different perspectives: top (402), front (404), and right side (406). A Point Cloud (408) representing the Installed Location of that Element is shown in each view as well. The arrow (410) illustrates the process of moving the model from the Design Location to an Approximate Installed Location as indicated by the Point Cloud, with that motion constrained to the two dimensions of space that are orthogonal to the front face of the stairs.

It should be noted that this is not an exhaustive list of embodiments of the invention, other embodiments are possible.

### Operation of Measuring and Reporting the Spatial Differences Between the Design Location and an Approximate Installed Location

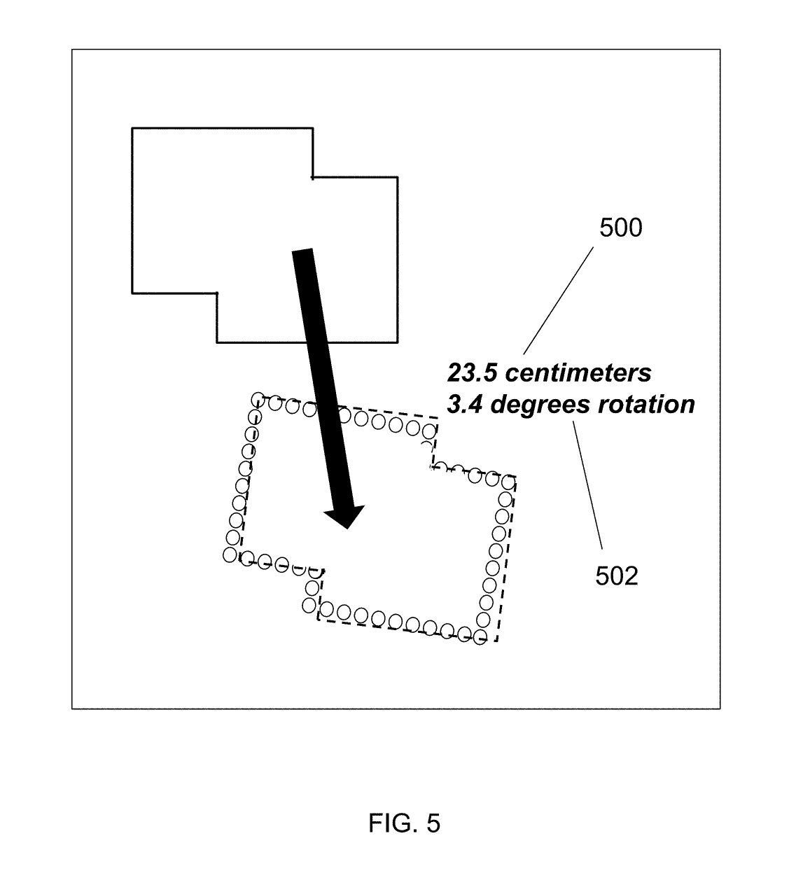

An operation to measure and report the spatial differences between the Design Location and an Approximate Installed Location is performed (block 210), e.g., by computer system 100. In some embodiments, the distances between vertices of the Design Model in the Design Location and the corresponding vertices of the Design Model in an Approximate Installed Location are computed, and the greatest distance is reported (500), as shown in FIG. 5. In some embodiments, the average distance is reported (500). In some embodiments, the median distance is reported (500). In some embodiments, the centroid of the Design Model in each location is compared and the distance between those centroids is reported (500). In some embodiments, a rigid body transform is computed to describe the offset between the two locations (Design and Approximate Installed) and a chosen point near the Design Model is chosen and transformed according to that rigid body transform, and the distance between its original location and its transformed location is computed and reported (500). In some embodiments, a rotational difference between the two locations is computed and reported (502).

It should be noted that this is not an exhaustive list of embodiments of the invention, other embodiments are possible.

An example of a given embodiment is useful to describe the operation of at least one embodiment of the above operations. In this embodiment, execution of a software application by a processor causes the processor to load a set of laser scan point measurements (Point Cloud) of a Scene, such as a new building under construction, with a staircase (the Element) that is installed thirty centimeters up and to the right of where the architect had intended the staircase to be installed (its Design Location). Execution of the application by the processor then causes the processor to load the geometry data describing the staircase (the Design Model). The application then causes the processor to execute instructions which loads the architect's intended installation location for that staircase (the Design Location). The application then causes the processor to execute instructions which graphically display both the Design Model (400) in its Design Location as well as the Point Cloud (408) showing where the staircase was actually installed onsite (the Installed Location). This graphical display is split into the three orthographic views shown in FIG. 4: the top view (402), the front view (404), and the side view (406). Execution of the application by the processor then allows a user to graphically drag a copy of the Design Model in each of the three independent orthographic views in such a way that the motion is constrained to the two dimensions of space that are orthogonal to the view's Perspective Vector. The user then is able to drag the copy of the Design Model thirty centimeters up and to the right (410) such that it falls as closely as possible to the Installed Location as indicated by the Point Cloud (an Approximate Installed Location). Execution of the application by the processor then causes the processor to execute instructions which computes the maximum distance (500) and rotational variance (502) between corresponding points on the Design Model in both the Design Location and an Approximate Installed Location, and this distance and rotational variance are reported to the user.

It should be noted that this is not an exhaustive list of embodiments of the invention, other embodiments are possible.

Accurately quantifying the deviation between intended installation locations (Design Locations) and actual installation locations (Installed Locations) for elements during construction is an important but often time-consuming process for construction projects. Quantifying these deviations during the construction process can enable early mitigation of construction mistakes, saving both time and money.

After these deviations have been discovered and quantified, the construction team has at least three options for dealing with each deviation: fix the installation of the Element in the field, adjust the Design Location in the plans, or ignore the deviation. Critical deviations in significant Elements often require remediation in the field. When substantial deviations are discovered in non-critical Elements, it is considered best practice to update the design plan to reflect as-built conditions to avoid problems with downstream construction processes that may be depending on the accurate installation of those Elements. Finally, a certain amount of deviation is generally considered acceptable during most construction projects, and when minor deviations that fall beneath this tolerance are discovered, the construction team may decide to ignore those deviations altogether.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. For example, it is possible to rearrange blocks 202, 204, and 206 in a different order without affecting the result. Those skilled in the art should also realize that such equivalent constructions do not depart from the spirit and scope of the present disclosure, and that they may make various changes, substitutions, and alterations herein without departing from the spirit and scope of the present disclosure. It is therefore intended that the protection granted hereon be limited only by the definition contained in the appended claims and equivalents thereof.

1. A method of indicating and computing displacement of Elements with respect to corresponding Design Locations of the Elements, said method comprising the steps of:
receiving, through a data interface, data describing a set of measurements (Measurement Data) of one or more Elements in a Scene;
receiving, through a data interface, data describing the geometry of one or more Elements (the Design Model) that are expected to exist in the Scene;
receiving, through a data interface, data describing the Design Location(s) of the Element(s);
enabling a user to position a graphical representation of the Design Model in an Approximate Installed Location indicated by the Measurement Data; and
measuring and reporting spatial differences between the Design Location and an Approximate Installed Location.

2. The method of claim 1, where the Measurement Data consists of a Point Cloud.

3. The method of claim 1, where a user positions a graphical representation of the Design Model in an Approximate Installed Location in three-dimensional space.

4. The method of claim 1, where spatial differences between the Design Location and an Approximate Installed Location include translational offsets between the two locations.

5. The method of claim 1, where spatial differences between the Design Location and an Approximate Installed Location include rotational offsets between the two locations.

6. The method of claim 1, where the initial starting position of the Design Model is determined by automatically fitting the Design Model to the Measurement Data, and the user is able to reposition the Design Model to an Approximate Installed Location by moving the Design Model from this initial starting position.

7. The method of claim 3, where the Design Model and Measurement Data are displayed within one or more views, and the positioning is constrained to motion within the two dimensions of space orthogonal to the Perspective Vector of each view.

8. The method of claim 1, further comprising performing at least one of:
updating the Design Location to reflect the measured spatial difference; or
updating the Approximate Installed Location to correct for the measured spatial difference.

9. A system for indicating and computing displacement of Elements with respect to corresponding Design Locations of the Elements, the system comprising:
a processor; and
a memory storing instructions which, when executed by the processor, cause the processor to:
receive, through a data interface, data describing a set of measurements (Measurement Data) of one or more Elements in a Scene;
receive, through a data interface, data describing the geometry of one or more Elements (the Design Model) that are expected to exist in the Scene;
receive, through a data interface, data describing the Design Location(s) of the Element(s);
enable a user to position a graphical representation of the Design Model in an Approximate Installed Location indicated by the Measurement Data; and
measure and report spatial differences between the Design Location and an Approximate Installed Location.

10. The system of claim 9, where the Measurement Data consists of a Point Cloud.

11. The method of claim 9, where a user positions a graphical representation of the Design model in an Approximate Installed Location in three-dimensional space.

12. The system of claim 9, where spatial differences between the Design Location and an Approximate Installed Location include translational offsets between the two locations.

13. The system of claim 9, where spatial differences between the Design Location and an Approximate Installed Location include rotational offsets between the two locations.

14. The system of claim 9, where the initial starting position of the Design Model is determined by automatically fitting the Design Model to the Measurement Data, and the user is able to reposition the Design Model to an Approximate Installed Location by moving the Design Model from this initial starting position.

15. The system of claim 11, where the Design Model and Measurement Data are displayed within one or more views, and the positioning is constrained to motion within the two dimensions of space orthogonal to the Perspective Vector of each view.

16. The system of claim 9, further comprising instructions, which when executed by the processor, cause the processor to perform at least one of:
updating the Design Location to reflect the measured spatial difference; or
updating the Approximate Installed Location to correct for the measured spatial difference.

17. A memory or a computer-readable medium storing instructions which, when executed by a processor, cause the processor to execute the method of claim 1.
